(19) United States
(12) Patent Application Publication
(10) Pub. No.: US 2025/0274389 A1
(43) Pub. Date: Aug. 28, 2025

(54) Lookup Table Engine Supporting Multiple Protocols

(71) Applicant: TEXAS INSTRUMENTS INCORPORATED, Dallas, TX (US)

(72) Inventors: Joseph Aronson, Dallas, TX (US); Denis R. Beaudoin, Rowlett, TX (US)

(21) Appl. No.: 18/941,780

(22) Filed: Nov. 8, 2024

Related U.S. Application Data
(60) Provisional application No. 63/556,922, filed on Feb. 23, 2024.

(51) Int. Cl. H04L 45/74; H04L 45/028

(52) U.S. Cl. CPC H04L 45/74; H04L 45/028

(57) ABSTRACT

A lookup table engine may be implemented in hardware logic and yet provide operation for a multitude of different communication protocols and packet types. A lookup table memory may be populated with rules that indicate, among other things, which bytes of a particular packet to extract, which comparisons to make to those extracted bytes, and actions to be taken based on the results of the comparisons. The lookup table engine may be implemented within a network accelerator, which receives a packet, and a processor core of the network accelerator may offload lookup operations to the lookup table engine.

### CROSS-REFERENCE TO RELATED APPLICATIONS

The present application claims the benefit of U.S. Provisional Patent Application 63/556,922, filed Feb. 23, 2024, the disclosure of which is hereby incorporated by reference in its entirety.

### TECHNICAL FIELD

The present disclosure relates generally to a lookup table engine and, more specifically, to a lookup table engine configured to support multiple protocols.

### BACKGROUND

Networks are made up of nodes connected by ports in various configurations. In order for a packet to be sent from one node to another node that is not directly connected, the middle nodes in the path must know where to send the packet. This may be accomplished by the source node sending information with the packet such as destination address to a first receiving node. The information gets inspected by the first receiving node and each receiving node thereafter, which may attempt to match this information in a programmed database of destination entries called a lookup table. Based on the result, the receiving node will forward the packet to another receiving node closer to the destination node. This continues until the packet reaches its destination node.

This lookup process by a node may be accomplished by software or hardware. Commonly this is done by hardware for speed and efficiency. Most hardware lookup table designs are fixed for a single protocol and for fields of packet information within that protocol. A fixed protocol and format may help meet performance requirements to maintain a specified network rate. However, even with these concessions, it often proves difficult to achieve a given performance for a given cost. Such solutions may also not be future-proof if the lookup entries and logic are unable to adapt to new versions and levels of protocols.

### SUMMARY

In an arrangement, a method includes: receiving a pointer to a first rule, where the first rule identifies a first plurality of bytes of a packet; accessing the first rule, according to the pointer, from a first memory; applying the first rule, including generating a search word that includes the first plurality of bytes and omits a second plurality of bytes of the packet; accessing a second rule, which is referred to in the first rule, wherein the second rule identifies a plurality of comparing operations to apply against a plurality of portions of the search word; performing the plurality of comparing operations according to the second rule; writing results of the plurality of comparing operations to a buffer; and alerting a processor core to the results of the plurality of comparing operations.

In an arrangement, a circuit includes: a first plurality of registers, wherein each register of the first plurality of registers is configured to receive data for a lookup operation from a respective processor core of a plurality of processor cores; a first memory configured to store a first plurality of rules, a second plurality of rules, and a plurality of lookup tables; and a plurality of lookup table engines configured to access the first memory and to access data from the first plurality of registers; wherein a first lookup table engine of the plurality of lookup table engines is further configured to: receive first data from a first processor core, wherein the first data references a first rule of the first plurality of rules for a first lookup operation and references a location of a packet in a second memory; generate a search word according to the first rule, including storing a first subset of bytes of the packet to a register and omitting to store a second subset of bytes of the packet to the register; access, according to the first rule, a second rule of the second plurality of rules; generate, according to the second rule, a plurality of portions of the search word; compare the plurality of portions of the search word to respective entries from the lookup tables according to the second rule; and write an event to a scheduler of the first processor core, based at least in part on results of comparing the plurality of portions of the search word.

In an arrangement, a network accelerator includes: a first processor core; a processor scheduler, communicatively coupled with the first processor core; and a lookup table engine, communicatively coupled with the processor scheduler, wherein the lookup table engine is configured to: receive first data from the processor core, and, in response, access a first rule and a second rule; generate a search word from a packet referenced in the first data, including storing a first portion of the packet and omitting to store a second portion of the packet based on the first rule; perform a plurality of comparing operations according to the second rule, wherein each comparing operation compares a respective byte of the search word to a respective byte from a lookup table entry; and write an event to the processor scheduler based in part on results of the plurality of comparing operations.

### BRIEF DESCRIPTION OF THE DRAWINGS

Having thus described the invention in general terms, reference will now be made to the accompanying drawings, wherein:

FIG. 1 is an illustration of an example lookup table engine, adapted according to some embodiments.

FIG. 2 is an illustration of an example method for performing a lookup operation, according to some embodiments.

FIG. 3 is an illustration of an example transfer rule, according to some embodiments.

FIG. 4 is an illustration of an example structure for a data memory, according to some embodiments.

FIG. 5 is an illustration of an example entry rule, according to some embodiments

FIG. 6 is an illustration of an example entry, according to some embodiments.

FIG. 7 is an illustration of an example method for handling a packet, according to some embodiments.

FIG. 8 is an illustration of an example network accelerator, according to some embodiments.

FIG. 9 is an illustration of an example system on-chip (SoC), which may include a network accelerator, such as the network accelerator of FIG. 8, according to some embodiments.

### DETAILED DESCRIPTION

The present disclosure provides a flexible lookup table engine that can be programmed to perform lookup operations on any protocol and any fields within those packets. This may be accomplished by three levels of lookup: tables/transfer rules, entry rules, and entries. These roughly correspond to protocol, fields, and match criteria.

In some examples, the lookup table engine supports multiple lookup tables and consequently protocols by utilizing multiple transfer rules. These transfer rules may pull data from the packet into an intermediate data word, such as a search word, to be used in the lookup. The transfer rules may also point to a set of entry phases contained in the table that pull from the search word for matching. An entry phase may include an entry rule and set of entries. Entry rules may specify which portion of the search word to compare, and the entries specify the match criteria. In an example, upon an entry match, the lookup engine writes the entry's results to the search word (space is reserved in search word for entry results). The entry may also specify what to do next, such as jump to the next entry phase or end lookup. This flexibility enables multiple packet fields and protocol levels to be compared and matched within the same lookup. When the lookup operation completes, the transfer rule may be used to write final results from the search word back to the packet to be used by further packet processing.

Compared to alternative techniques, the programmability and general nature of entry and matching logic in the disclosure may provide greater versatility and improved future-proofing versus a hard-coded lookup engine that inspects specific packet fields of a certain protocol.

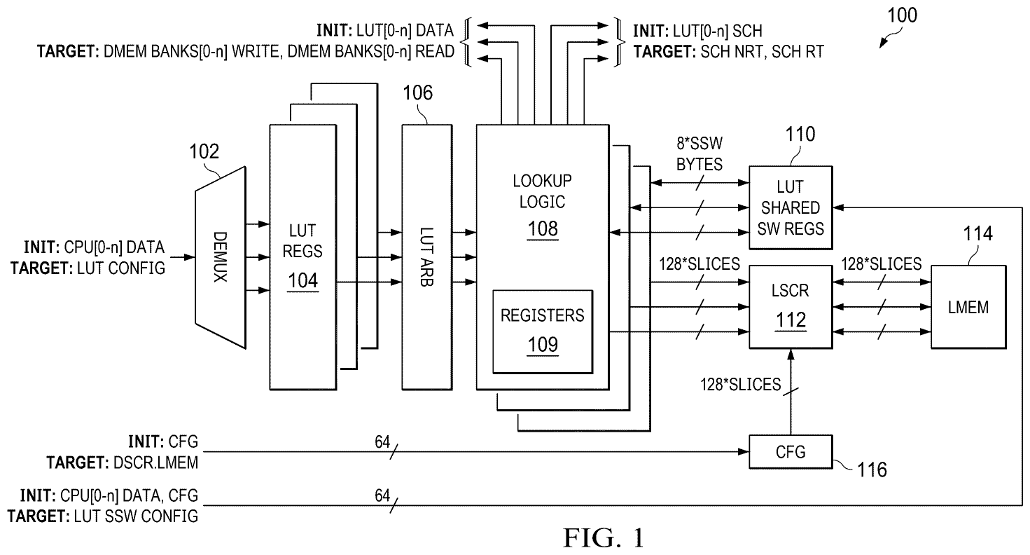

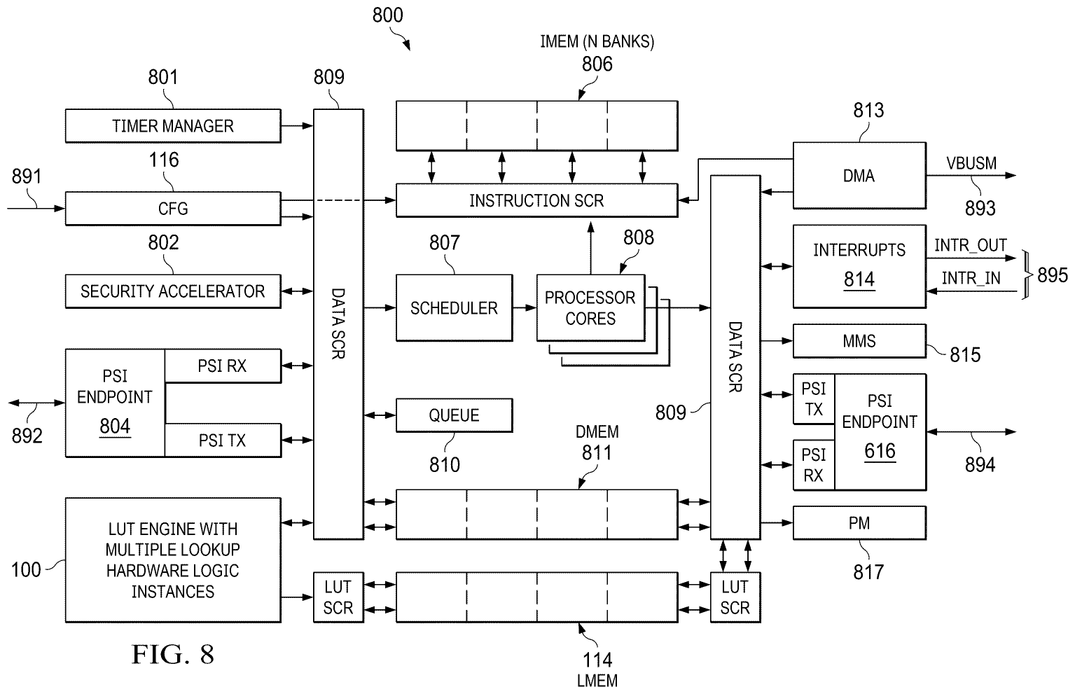

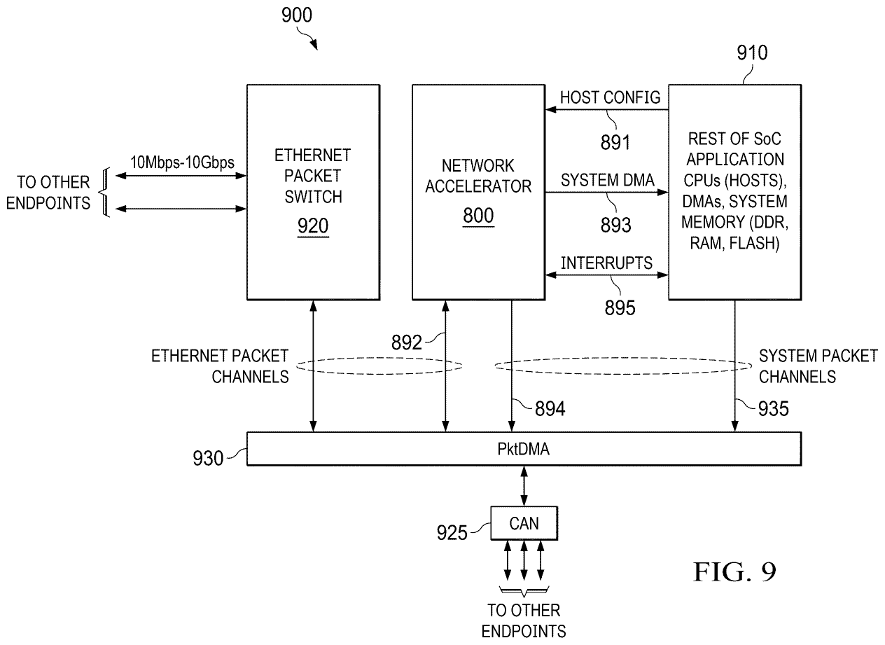

FIG. 1 is an illustration of example lookup table engine 100, adapted according to some embodiments. Lookup table engine 100 may be implemented using fixed-purpose (i.e., hardcoded) circuitry, programmable circuitry, or a combination thereof and may be incorporated into another circuit, such as in a network accelerator, which itself is implemented within a system on-chip (SoC). An example of a network accelerator includes network accelerator 800 of FIG. 8, and an example SoC includes SoC 900 of FIG. 9.

In one example, a packet comes into a network accelerator, such as network accelerator 800 of FIG. 8. A processor, such as one of processor cores 808 of FIG. 8, may then offload lookup operations to lookup table engine 100. The lookup table engine 100 may receive data from the processor core 808, which triggers the lookup table engine 100 to use its lookup table resources to determine a processor operation. The lookup table engine 100 may determine a processor operation based on rules, contents of lookup tables, and the content of the packet. The lookup table engine 100 may then return a pointer or other data indicative of a processor operation to the processor core. Examples of processor operations may include forwarding the packet to a particular destination, dropping the packet, performing statistical analysis on the packet, and the like.

The lookup table engine 100 includes demultiplexer 102, which receives data from a plurality of processor cores. For instance, the network accelerator may include a plurality of processor cores 808, which are configured to write data to lookup table registers 104 to cause the lookup table engine 100 to perform a lookup operation. The demultiplexer 102 receives the data and directs the data to an appropriate one of the registers 104. In one example, registers 104 may include a plurality of registers, where each one of the registers is assigned to a respective one of the processor cores 808. The demultiplexer 102 may then direct data from a processor core to a corresponding one of the registers 104 in response to a processor ID from the requesting processor core.

The lookup table engine 100 of FIG. 1 is set up for parallel operation. For instance, as noted above, multiple ones of the processor cores 808 may request lookup operations from lookup table engine 100, and these lookup operations may be performed concurrently. Such parallel operation may be facilitated by the lookup table registers 104, arbitrator 106, and lookup hardware logic 108. The arbitrator 106 may be configured to read out data from the registers 104 and pass that data, the contents of one register at a time, to an available portion of lookup hardware logic 108. In some examples, the requests from the processor cores 808 may not be assigned a priority, in which case the arbitrator 106 may go through the registers 104 in a round-robin manner. In another example, some of the requests may be labeled as real time (RT) or as others may be labeled as nonreal time (NRT), in which case the arbitrator 106 may assign RT requests to available portions of lookup hardware logic 108 first before assigning NRT requests.

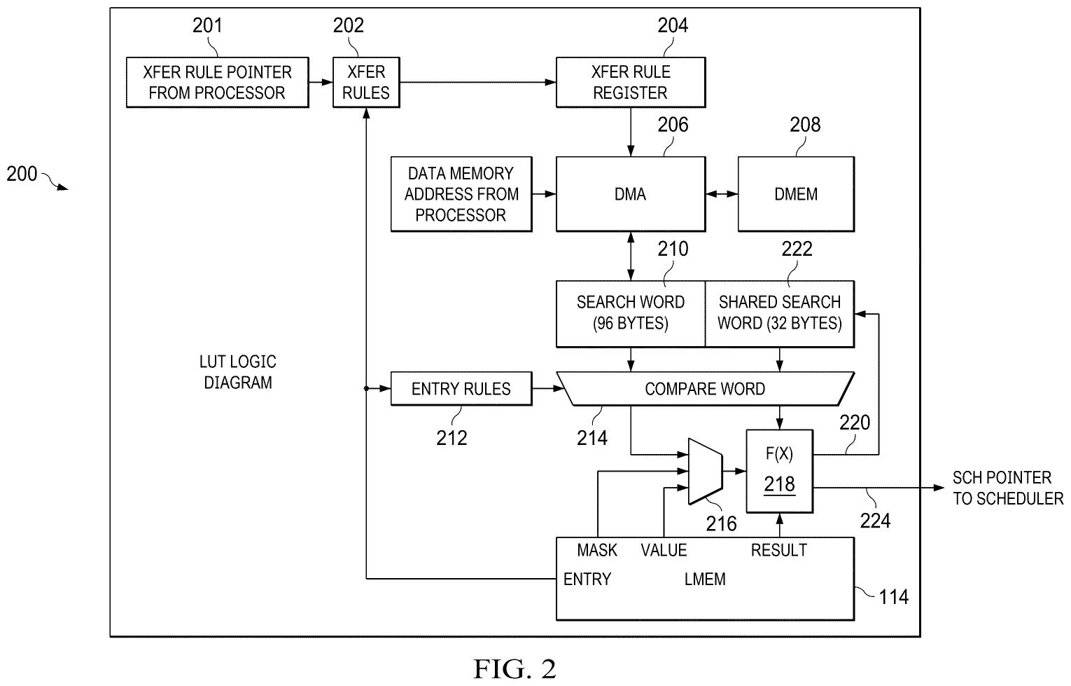

Lookup hardware logic 108 may be configured as multiple, parallel portions of hardware logic, each configured to perform a lookup operation based on a request. A given portion of lookup hardware logic 108 may receive a request, via arbitrator 106, and perform a lookup operation by accessing rules and entries from memory 114 as well as by accessing the packet itself, which is stored in another memory (e.g., data memory 811 of FIG. 8). Each portion of lookup hardware logic 108 may perform a lookup operation by performing the operational flow 200 of FIG. 2.

A lookup operation may include writing an event to a scheduler of a processor, such as scheduler 807 of FIG. 8. The event may correspond to a processor operation, which the scheduler may pass to an appropriate one of the processor cores 808.

A lookup operation may also include writing results to the memory storing the packet (e.g., the data memory 811 of FIG. 8) and/or writing results to the shared software registers 110. The shared software registers 110 are configured to be accessed by any of the processor cores 808 in the network accelerator 800. For instance, statistics that may be useful for other processes may be one kind of data that may be written into the registers 110.

Switching element 112 may be used to communicatively couple the lookup hardware logic 108 to the memory 114. Furthermore, lookup table engine 100 includes configuration interface 116, which is configured to receive configuration data. The configuration interface 116 may be configured to communicate with the memory 114 via the switching element 112 to add, delete, or modify entries in the memory 114. For example, the configuration interface 116 may allow an external application processor core (e.g., in 910 of FIG. 9) to configure transfer rules, entry rules, and entries.

FIG. 2 is an illustration of an example operational flow 200, for performing a lookup operation, according to some embodiments. Operational flow 200 may be performed by lookup hardware logic 108. More specifically, a given one of the parallel portions of lookup hardware logic 108 may perform operational flow 200.

In operational flow 200, the lookup hardware logic 108 may perform a three-stage lookup operation on a packet using the table data structure stored in memory 114. The first stage determines a transfer rule within the table that specifies one or more portions of the packet to use in a search word. The second stage determines an entry rule within the table that specifies one or more portions of the search word to use to query a set of entries. The third stage determines an entry within the table that updates the search word. The updated search word may be used for another lookup iteration or may be used to modify one or more portions of the original packet. In some such examples, the transfer rule specifies portions of the search word to copy into (e.g., append or overwrite) specified portions of the packet.

Thus, the lookup operation may make modifications to the header, the data payload, and/or the remainder of the packet using the search word. For more complex modifications to the packet, the entry within the table may configure a task for a processor core scheduler that may cause the processor core to read in the packet, modify the packet, and write the modified packet back to memory. Additionally, or in the alternative, the task may cause the processor core to take other actions with respect to the packet.

A processor core (e.g., one of the processor cores 808 of FIG. 8) may initiate the lookup operation by writing a data memory address of a packet to a group of the registers 104 that corresponds to the processor core. The processor core may also write a pointer for a transfer rule to the group of the registers 104 at action 201. Although not shown in operational flow 200, the processor core may write data to indicate whether the request is real time or nonreal time, to include writing such data to the group of the registers 104. In this example, when the processor core writes the data to the registers 104, that acts as a request for a lookup operation.

At actions 202 and 204, the lookup hardware logic 108 uses the transfer rule pointer as an address to read a transfer rule from the memory 114 and to store that transfer rule to internal registers 109 of the lookup hardware logic 108. At actions 206 and 208, the lookup hardware logic 108 uses the data memory address from the processor core to identify the packet in the data memory (DMEM, e.g., 811 of FIG. 8). The lookup hardware logic 108 may use the transfer rule to read out specific bytes of the packet via direct memory access (DMA) logic at actions 206 and 208. The lookup hardware logic 108 may store the bytes of the packet as a search word in its own internal registers 109 at action 210.

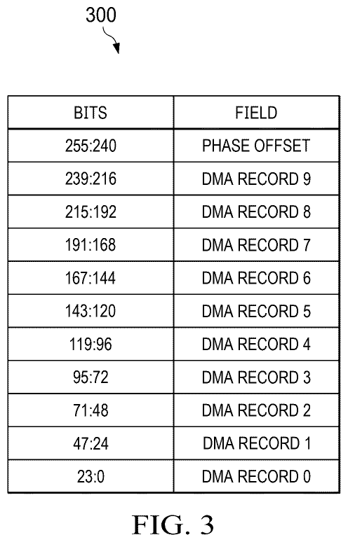

To begin constructing a new search word, the lookup hardware logic 108 deletes an old search word from its own internal registers 109 and then generates the new search word at action 210. The lookup hardware logic 108 may generate the new search word based on portions of the packet specified by the transfer rule. An example transfer rule 300 is illustrated in FIG. 3, according to some embodiments. Example transfer rule 300 may be data stored in the memory 114 and accessed by the lookup hardware logic at action 202 based on the transfer rule pointer from the processor core. In this example, transfer rule 300 includes 256 bits, though the scope of implementations is not limited to any size for a transfer rule. Example transfer rule 300 includes 10 DMA records 0-9. Each of the DMA records 0-9 specifies a portion of the packet by specifying bytes within the data memory (e.g., memory 811) at which the packet is stored. Each of the DMA records 0-9 may point to a different byte or bytes, and the totality of the DMA records 0-9 may refer to less than the entirety of the packet. Put another way, the lookup hardware logic 108 may read the portions of the packet specified by the DMA records 0-9 and, in doing so, may read less than the full packet and may omit reading other portions of the packet.

The DMA records 0-9 or other portions of the transfer rule may specify how to generate a search word by writing each of the portions of the packet to registers 109 internal to the lookup hardware logic 108. For example, the DMA records 0-9 may specify the order of the respective portions of the packet in the search word. The lookup hardware logic 108 may read out the portions of the packet specified by the DMA records 0-9 and write those read-out portions to its internal registers 109 as a search word. Thus, the search word may include some, but not all, bytes of the packet. Furthermore, while example transfer rule 300 includes 10 DMA records, the scope of implementations may include any appropriately scaled transfer rule, which includes more or fewer DMA records.

The transfer rule specifies how to generate the search word to include relevant bytes from the packet and to leave out irrelevant bytes. The particular relevant and irrelevant bytes of a given packet may depend upon the packet type. For instance, an ethernet packet may have a different format and different relevant portions than would a controller area network (CAN) frame. For instance, example relevant portions of an ethernet packet may include destination address, virtual local area network ID, media access control address, ether type, Internet protocol addresses, TCP/UDP port numbers, and the like. For a CAN frame, examples of relevant data may include CAN ID and CAN port. Of course, for a given use case, relevant data may be the same or different. Examples of data that may be irrelevant in some use cases may include user data in payloads. Nevertheless, a given transfer rule may be programmed to extract any appropriate data from the packet to generate the search word.

In this example, the processor core determines which transfer rule for the operational flow 200 to use. The processor core may determine an appropriate transfer rule using any criteria. For instance, in some implementations, a stream of packets from a single endpoint may include a thread ID, and the thread ID may be used to identify the endpoint. Example endpoints may include packet switches 920, 925 of FIG. 9. The processor core may parse the thread ID to determine the endpoint and then determine a transfer rule based on the thread ID. In such cases, an endpoint may be limited to a single communication protocol, such as ethernet, and the thread ID would thus lead to one or more transfer rules tailored for ethernet. In another example, the endpoint may be associated with Control Area Network (CAN) protocol and, thus, the thread ID would lead to one or more transfer rules tailored for CAN. Additionally, and for each protocol, there may be multiple packet types, and the processor core may be configured to identify a packet type within a protocol and to select a transfer rule based at least in part on the packet type. An example includes an acknowledgment (ACK) packet in ethernet, which is a particular type of packet within the ethernet protocol, and the processor core may be configured to select a transfer rule specifically for an ACK packet.

In any event, the processor core provides a pointer to a transfer rule, and that transfer rule may be one of multiple different transfer rules stored in the memory 114. Each of the transfer rules may be tailored to extract specific bytes from a particular packet type. In this example of operational flow 200, the transfer rule that is applied by the lookup hardware logic 108 is selected by the processor core for the protocol of the packet and, perhaps more specifically, for the type of packet within the protocol. Other transfer rules may be stored in the memory 114 for other protocols and packet types, and subsequent transfer rule pointers may point toward those other transfer rules.

In some examples, operational flow 200 utilizes the search word specified by the transfer rule and based on the packet and further utilizes a shared search word 222. The shared search word 222 may be shared among the various instances of the lookup hardware logic 108, so that a lookup based on a first packet on an instance of the lookup hardware logic 108 can update the shared search word 222 used on the other instances of the lookup hardware logic 108. Thus, the complete search word used by the lookup hardware logic 108 may include the search word 210 portion and the shared search word 222 portion.

With the complete search word generated, the lookup hardware logic 108 may search the table data structure in memory 114 for a corresponding entry to determine an operation to perform on the packet. In some examples, the entries are grouped into phases, and example transfer rule 300 includes a phase offset field. The phase offset field directs the lookup hardware logic 108 to an address of an entry rule that marks the start of a phase of entries and specifies relevant portions of the search word to use to query the entries of the phase. Accordingly, the address of the entry rule may be separated from the address of the transfer rule within memory 114 by a space equal to the phase offset. In other words, the example transfer rule 300 points to a corresponding entry rule. In some examples, multiple transfer rules may point to a same entry rule.

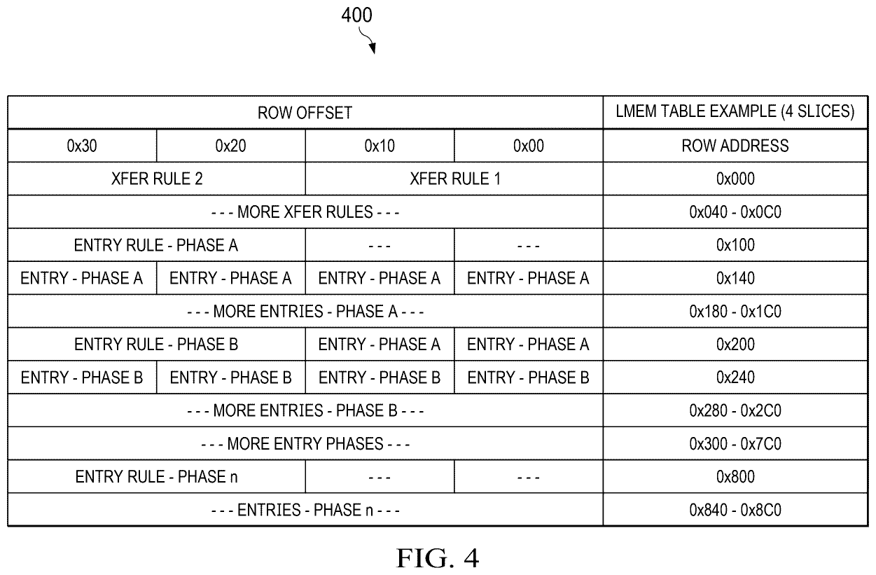

FIG. 4 is an illustration of an example structure 400 for memory 114, according to some embodiments. In this example, the memory 114 includes four slices and multiple columns and rows, and the scope of implementations may include any appropriate quantity of slices, columns, and rows. The different rows store different data, and each of the different rows has its own row address, where a particular piece of data within a row may be identified by a row offset within the row. The first addresses in numerical order are used to store the transfer rules (Xfer Rule). The rows following, in numerical order, include a first entry rule (Entry Rule-Phase A), which is followed by the entries applicable to Entry Rule-Phase A. The remaining addresses in numerical order within memory 114 include further entry rules (e.g., Entry Rule-Phase B) and their respective associated entries. Of note is that each entry rule is followed by its associated entries, so that the lookup hardware logic 108 may read from a contiguous address range to access both an entry rule and its associated entries.

Going back to FIG. 2 and example operational flow 200, the lookup hardware logic 108 has generated the search word at action 210. The lookup hardware logic 108 uses the phase offset field of the transfer rule to access a corresponding entry rule at action 212. In short, an entry rule specifies comparing operations to be performed against the search word. An entry rule may also specify where to write results of the comparing operations within the search word in the internal registers 109 of lookup hardware logic 108.

In one example, the entry rule corresponds to a plurality of entries, such as in FIG. 4, in which Entry Rule-Phase A corresponds to the entries labeled Entry-Phase A. The entry rule may specify a first portion of the search word to be compared using a first rule. The first portion of the search word in this example may be referred to as a compare word at action 214. The entry rule may specify further portions to generate subsequent compare words, each of those compare words compared using an entry.

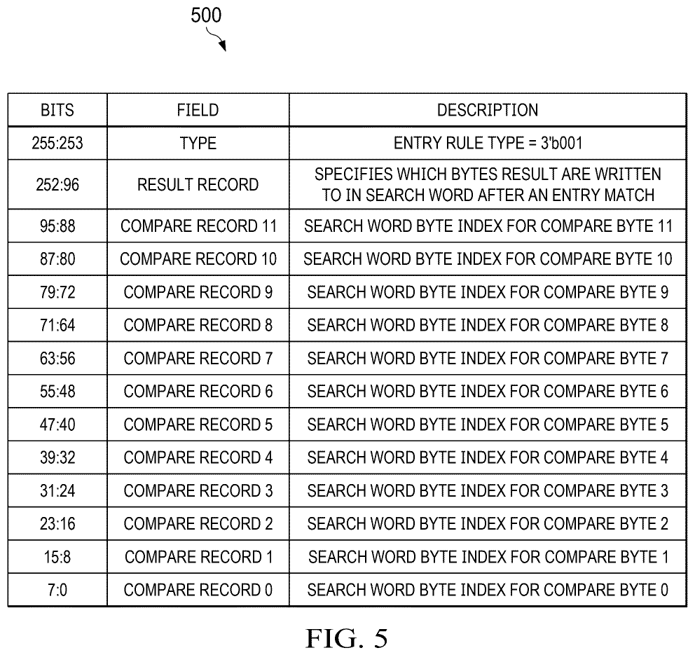

FIG. 5 is an illustration of example entry rule 500, according to some embodiments. The entry rule 500 may specify a value to be used in the comparison with the compare word, a portion of the search word to modify if the comparison is true, a value for the portion of the search word (e.g., within the search word 210 portion and/or the shared search word 222 portion) to be modified, one or more scheduler parameters for an operation to be performed on the packet, and/or other suitable parameters and values.

Example entry rule 500 includes a Type field, which identifies the entry rule as an entry rule. The example entry rule 500 also includes 12 compare records 0-11. Each of the compare records specifies a respective byte index within the search word, where that byte index is a portion of the search word—a compare word at action 214. In the example of FIG. 4, an example entry rule includes Entry Rule-Phase A, and the entries that are used to compare with the compare word include Entry-Phase A. Example entry rule 500 also includes a Result Record field, which specifies where to write results of the compare operations within the search word in the internal registers 109 of the lookup hardware logic 108. The size of entry rule 500 is for example only, and the scope of implementations may include any appropriately sized entry rule.

As noted above, the lookup hardware logic 108 generates a compare word 214 according to a byte index of a compare record of the entry rule. The corresponding entry may include a mask and a value, which the lookup hardware logic 108 reads at action 216. At action 218, the lookup hardware logic 108 may compare the compare word to the mask and value and then return the results at action 220. The lookup hardware logic 108 may generate a compare word 214, compare a value and mask to the compare word at action 218, and return the results as many times as there are entry rules that generate compare words. In the example of FIG. 5, there are 12 total compare records, which allows for generation of a single compare word and performance of 12 comparing operations. However, some embodiments may not use all of the compare records, so the lookup hardware logic 108 may perform fewer than 12 comparing operations. The scope of implementations may include any appropriate number of compare operations for a given entry rule.

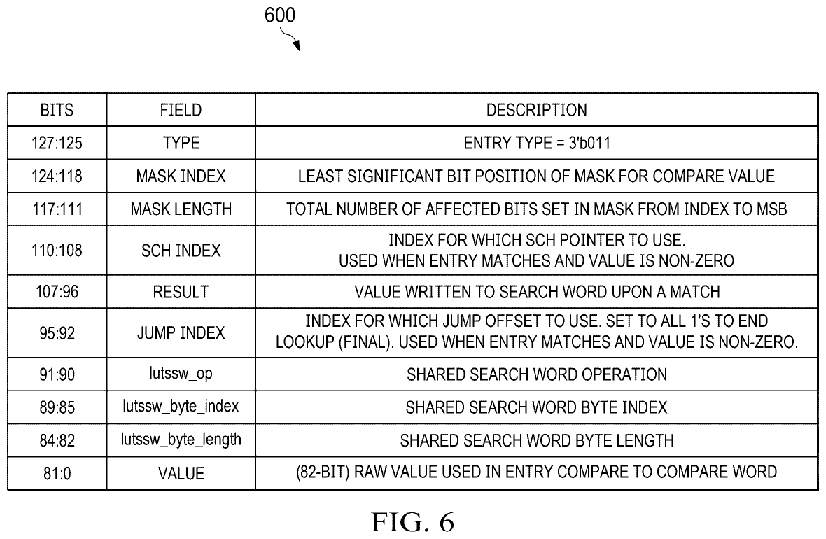

A given entry may include a multitude of fields setting out the particular parameters for a given comparing operation against a compare word. FIG. 6 is an illustration of example entry 600, according to some embodiments.

Entry 600 includes a Type field, indicating that it is an entry. Entry 600 also includes Mask Index and Mask Length fields, which indicate a bit range within a compare word to ignore for the comparing operation. The Scheduler Index field provides an index for a scheduler pointer. In an example, if a comparing operation is positive (e.g., a match exists), then the lookup hardware logic 108 may use the Scheduler Index field to retrieve a scheduler pointer from its own internal registers 109 and pass that scheduler pointer to a processor scheduler (e.g., scheduler 807 of FIG. 8). The Result field indicates a value to be written to the search word if the comparing operation is positive.

The Jump Index provides an index within memory 114 for the lookup hardware logic 108 to jump to. In this example, the bits 82:91 identify whether the comparing operation is a shared operation and, if so, where to write results. For instance, a shared operation may have its results written both to the search word in the internal registers 109 of the lookup hardware logic 108 as well as to shared registers 110. The Value field indicates a value for a match comparison. For instance, the lookup hardware logic 108 may perform a Boolean operation on the un-masked bits of the compare word against the value in the Value field and determine a match or not a match based on the Boolean operation.

While the example of FIG. 6 refers to an exact match with the Value field, the scope of implementations is not so limited. Rather, it is within the scope of implementations to include other relationships than exact matches, such as less than, greater than, and the like. In fact, multiple Value fields may be used and ANDed together to create a range of values so that a match would result from the un-masked bits of the compare word falling within the defined range. Additionally, it is within the scope of implementations for transfer rules, entry rules, and entries to be programmatically defined for a given embodiment. In other words, fields, number of fields, length of data items, and the like may be configured to serve a given embodiment.

Going back to FIG. 2, lookup hardware logic 108 may generate a compare word 214, compare a value and mask to the compare word at action 218, and return the results as many times as there are entry rules to generate compare words. For a given compare operation, if the compare operation is a shared operation, then operational flow 200 may include writing the results at action 220 to both the search word 210 and the shared search word 222. Further, operational flow 200 may include transmitting a scheduler pointer to a processor scheduler at action 224 based on the result of the comparing operation and the content of the respective entry. In some examples, not every entry causes a scheduler pointer to be transmitted at action 224; rather, some sets of entries may be programmed so that only some of the entries indicate a scheduler pointer. In an example in which the compare operation is marked as either a real time operation or a nonreal time operation, the lookup hardware logic 108 may transmit the scheduler pointer to either a real-time interface or a non-real-time interface of the scheduler.

Once the lookup hardware logic 108 has performed the comparing operations for the compare words, the search word 210, which is stored to the internal registers 109 of the lookup hardware logic 108, is complete. The lookup hardware logic 108 may then write the search word, including the results of the comparing operations, to the data memory (e.g., memory 811 of FIG. 8) according to the DMA records of the applicable transfer rule. For instance, the DMA records of the applicable transfer rule may instruct the lookup hardware logic 108 to write the search word to an address range that also includes the packet in the data memory. The scheduler pointer, which the lookup hardware logic 108 passed to the processor scheduler, may then cause the processor core to perform an action on the data memory address range that includes the packet and the search word.

Various embodiments may include advantages over other systems. For instance, the transfer rule, entry rule, entry hierarchy of operational flow 200, and used by lookup engine 100, may provide further functionality over prior systems. Specifically, an engineer may program transfer rules, entry rules, and entries to accommodate a plurality of communication protocols and packet types. As noted above, the memory 114 may store a multitude of different transfer rules, each of those transfer rules being adapted to address a particular communication protocol and/or packet type. In this manner, lookup engine 100 may be configured to perform appropriate actions for any expected packet. This is in contrast to other systems, which may only handle a single packet type. Furthermore, the lookup engine 100 may be built using hardware logic, thereby being efficient as to number of transistors and semiconductor area.

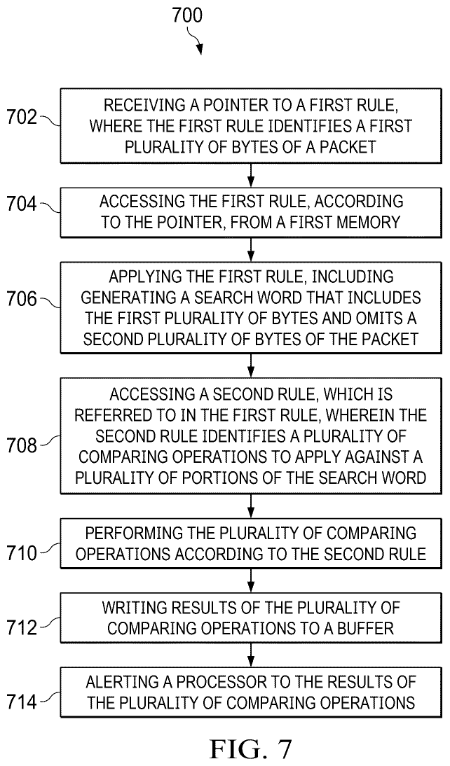

FIG. 7 is an illustration of example method 700, for handling a packet, according to some embodiments. Example method 700 may be performed, e.g., by a lookup engine, such as lookup engine 100 of FIG. 1.

Before the lookup engine begins its actions, a processor core (e.g., a processor core 808 of FIG. 8) may offload its lookup functions to the lookup engine. For instance, in this example, a processor core may be alerted that a packet has been received by a device, such as a network accelerator. An example of a network accelerator is described in more detail with respect to FIG. 8. The processor core may check a thread ID, which may imply or otherwise identify a communication endpoint from which the packet was received, a protocol, and perhaps a packet type. The processor core uses any appropriate information, such as a thread ID, packet scanning information, or the like, to determine an appropriate transfer rule for the packet. The processor core then sends, to the lookup engine, a pointer to the transfer rule and a pointer to a location in data memory of the packet. An example is described with respect to FIG. 2, where the processor core transmits a transfer rule pointer and a data memory address to the lookup engine.

At action 702, the lookup engine receives a pointer to a first rule. In this example, the first rule identifies a first plurality of bytes of a packet. An example may include a transfer rule, which identifies some, but not all, bytes of the packet. Action 702 includes receiving a pointer, and the lookup engine may use the pointer to access the first rule at action 704. For instance, the lookup engine may access the first rule from a data address in a first memory according to the pointer. The first memory may include a different memory than a data memory that stores the packet. For instance, the first memory may correspond to memory 114 of FIG. 1, and the data memory may correspond to memory 811 of FIG. 8.

At action 706, the lookup engine applies the first rule. Action 706 may include generating a search word based on the plurality of bytes identified by the first rule. In one example, the lookup engine may extract the identified bytes from the packet in the data memory and write those extracted bytes to registers 109. In this example, the search word includes some bytes from the packet but not all bytes of the packet. In one example, relevant data may include some header data that may indicate source or destination information, although any packet data may be relevant data in some instances. At action 706, the search word, written to the internal registers 109, includes a subset of the packet but less than the full packet.

At action 708, the lookup engine accesses a second rule. In one example, the second rule is referred to in the first rule, such as by the transfer rule including address information for an entry rule (a second rule). The second rule may identify a plurality of comparing operations to apply against a plurality of portions of the search word. Examples are described above in which the entry rule includes a multitude of compare records, where each compare record identifies a byte or bytes to be compared using an entry. There are as many comparing operations as there are compare records and entries in this example.

At action 710, the lookup engine performs the comparing operations according to the second rule. For instance, the lookup engine may include hardware logic (e.g., lookup hardware logic 108), which includes Boolean logic gates operable to receive compare words and values from the entries. The Boolean logic gates output results. In some examples, the lookup engine may store the results with the search word in the internal registers 109.

At action 712, the lookup engine writes the results of the plurality of comparing operations to a buffer. For instance, the lookup engine may modify portions of the search word in action 710 based on comparing operations, and at action 712, the transfer rule and/or other configuration element causes the lookup engine to write portions of the search word to portions of the packet. However, the scope of implementations may include writing the results of the comparing operations to any appropriate place.

At action 714, the lookup engine alerts a processor core to the results of the plurality of comparing operations. In one example, the lookup engine may transmit a scheduler pointer to a scheduler (e.g., scheduler 807 of FIG. 8) of the processor core. The particular scheduler pointer may be determined by the results of the plurality of comparing operations, such as matches on some comparing operations or lack of matching on some comparing operations. The scheduler pointer may direct the processor core to the address range that stores the results as well as identify an operation that may cause the processor core to perform a particular action with respect to the packet. Examples of actions that may be performed by the processor core include modifying the packet, dropping the packet, forwarding the packet to a destination, and the like.

The scope of embodiments is not limited to the series of actions 702-714. Rather, other embodiments may add, omit, rearrange, or modify some of the actions. For instance, some embodiments may repeat method 700 for each packet that is received, and packets may be received continually or periodically during normal operation of a computing device, such as the SoC 900 of FIG. 9.

The lookup operations described above may be employed for a variety of system uses in some examples. In one example, a network accelerator may use the lookup table operations to perform ethernet IPv4 address lookup and routing/forwarding. For instance, an ethernet frame with an IPv4 address is received and is processed, such as according to FIG. 2 and FIG. 7. A lookup operation may match a frame's IPv4 address with configured IPv4 addresses in memory 114. Such matching may cause the lookup engine 100 to indicate to the processor where the frame should be routed or forwarded, such as to another ethernet port or to an application processor core.

In another example use, the lookup operation may facilitate an ethernet access control list (ACL). For instance, an ACL entry may include layer 2-layer 4 fields (e.g., MAC addresses through TCP/UDP/CDMP ports). Each ACL entry may specify whether to allow or deny a matching frame. The lookup table memory 114 may be configured to implement such ACL entries in a priority order. For instance, the entries may be configured so that match results indicate whether to drop or forward a given frame.

In yet another example use, the lookup operation may facilitate CAN frame/protocol data unit (PDU) routing. In one example, a CAN frame or PDU as received and starts being processed, such as described above with respect to FIG. 2 and FIG. 7. If the lookup operation matches a CAN ID and/or a CAN port or other CAN field, then the match results may be configured to indicate where the frame or PDU should be routed or forwarded.

FIG. 8 is an illustration of an example network accelerator 800, which may include a lookup engine (e.g., lookup engine 100 of FIG. 1), according to some embodiments. The example network accelerator 800 may be implemented within a system on-chip (SoC) such as example SoC 900 of FIG. 9.

Network accelerator 800 includes a plurality of processor cores 808, which may include any appropriate processor cores, whether general purpose or otherwise and having any sized instruction set. In one example, each of the processor cores 808 execute firmware to provide processing functionality for network accelerator 800. For instance, timer manager 801 may perform an action that includes transmitting a function indication and an argument to the scheduler 807 upon expiry of a timer. Scheduler 807 may then pass that function indication and argument to one of the processor cores 808. Processor cores 808 may fetch instructions from instruction memory 806 or receive instruction pointers from direct memory access (DMA) interface 813 via bus 893.

An application processor core (e.g., in 910) may offload network functions to the network accelerator 800 so that the application processor core does not have to perform those functions itself. Configuration interface 116 allows for an application processor core to communicate with any of the components of network accelerator 800. For instance, an application processor core may communicate via bus 891, and such communication may write to registers 104 and/or may cause an instruction to be transmitted to one of the processor cores 808.

Security accelerator 802 may perform security functions on behalf of the processor cores 808. For instance, some types of packets (e.g., ethernet packets) may be designated as un-trusted. In such an example, the processor cores 808 may cause such packets to be indicated as either secure or not secure by security accelerator 802 before further processing.

Packet switch interface (PSI) end points 804 and 816 may receive packets and transmit packets into and out of the network accelerator 800 via buses 892 and 894, respectively. Upon receiving a packet, a PSI endpoint 804, 816 may perform a read operation with memory manager (MMS) 815 to cause space to be allocated within the data memory 811. Once space in the data memory 811 is allocated, the PSI endpoint 804, 816 may then store that packet to the data memory 811 in the allocated address range.

Network accelerator 800 includes two PSI endpoints 804, 816 for increased bandwidth, where PSI endpoint 804 is dedicated for ethernet use, and PSI endpoint 816 is dedicated to other packet protocols. Nevertheless, various embodiments may be adapted for either more or fewer PSI endpoints as appropriate.

An application processor core may configure actions to be taken for particular packets in some examples by writing to lookup table entries in lookup table memory 812. When a packet is received and ready for processing, a processor core 808 may cause lookup table engine 100 to perform a lookup operation within the lookup table entries in lookup table memory 114. A lookup operation may result in subsequent actions, such as events being sent to scheduler 807 by lookup engine 100, where such event may cause an action by a processor core 808.

Queue manager 810 may be used by the processor cores 808 to manage queues in some examples.

The larger system in which network accelerator 800 is implemented (e.g., SoC 900) may transmit interrupts to the processor cores 808 via interrupt interface 814 and buses 895.

Priority manager 817 is implemented to prioritize some packets over other packets, based on configuration data from an application processor core. For instance, some packets may include data indicating a priority level, and the priority manager 817 may perform priority functions, such as enforcing an order of data memory allocation for packets based on priority levels of the packets.

The various components are communicatively coupled within network accelerator 800 by data switches 809.

FIG. 9 is an illustration of an example SoC 900, according to some embodiments. Network accelerator 800 may be implemented on the SoC 900, though the scope of implementations may include network accelerator 800 being implemented in any appropriate system for offload of network functions by any appropriate processor core.

In the present example, ethernet packets may be received by the ethernet packet switch 920. Packets of other protocols, such as control area network (CAN), may be received by packet switch 925. However, the scope of implementations may include more packet switches or fewer packet switches to handle more or fewer communication protocols as appropriate.

Continuing with a packet receive operation, the packets from packet switches 920, 925 are then transmitted to packet direct memory access 930, which in this example, formats the various packets into one or more formats that are efficient for processing by network accelerator 800. Once the packet DMA 930 has formatted the packets, packet DMA 930 may transmit the packets to the network accelerator 800 via buses 892, 894. Packet direct memory access 930 may communicate with the rest of the SoC 910 through system packet channels 935.

As noted above, the network accelerator 800 may perform network functions on the packets, which allows network functions to be offloaded from the rest of the SoC 910. Examples of operations that the network accelerator 800 may perform include, but are not limited to, reformatting a packet from one protocol to another (e.g., ethernet to CAN or vice versa), dropping a packet, forwarding a packet to a different endpoint, sending payload data from a packet to a component of the rest of the SoC 910, and the like. For an outgoing packet, the network accelerator 800 may transmit such packet to the packet DMA 930 via one of buses 892, 894 to either ethernet packet switch 920 or packet switch 925. The network accelerator 800 may also transmit the payload data from the packet to the rest of the SoC 910 via bus 893.

The rest of the SoC 910 may be configured as appropriate. For instance, the rest of the SoC 910 may include one or more processor cores (e.g., application processor cores, digital signal processing cores, and the like) system memory, memory interfaces or accelerators, and the like.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale. In the following discussion and in the claims, the terms “including,” “includes,” “having,” “has,” “with,” or variants thereof are intended to be inclusive in a manner similar to the term “comprising,” and thus should be interpreted to mean “including, but not limited to . . . .” Also, the terms “coupled,” “couple,” and/or or “couples” is/are intended to include indirect or direct electrical or mechanical connection or combinations thereof. For example, if a first device couples to or is electrically coupled with a second device that connection may be through a direct electrical connection, or through an indirect electrical connection via one or more intervening devices and/or connections. Elements that are electrically connected with intervening wires or other conductors are considered to be coupled. Terms such as “top,” “bottom,” “front,” “back,” “over,” “above,” “under,” “below,” and such, may be used in this disclosure. These terms should not be construed as limiting the position or orientation of a structure or element but should be used to provide spatial relationship between structures or elements.

The term “semiconductor die” is used herein. A semiconductor device can be a discrete semiconductor device such as a bipolar transistor, a few discrete devices such as a pair of power FET switches fabricated together on a single semiconductor die, or a semiconductor die can be an integrated circuit with multiple semiconductor devices such as the multiple capacitors in an A/D converter. The semiconductor device can include passive devices such as resistors, inductors, filters, sensors, or active devices such as transistors. The semiconductor device can be an integrated circuit with hundreds or thousands of transistors coupled to form a functional circuit, for example a microprocessor or memory device. The semiconductor device may also be referred to herein as a semiconductor device or an integrated circuit (IC) die.

The term “semiconductor package” is used herein. A semiconductor package has at least one semiconductor die electrically coupled to terminals and has a package body that protects and covers the semiconductor die. In some arrangements, multiple semiconductor dies can be packaged together. For example, a power metal oxide semiconductor (MOS) field effect transistor (FET) semiconductor device and a second semiconductor device (such as a gate driver die, or a controller die) can be packaged together to from a single packaged electronic device. Additional components such as passive components, such as capacitors, resistors, and inductors or coils, can be included in the packaged electronic device. The semiconductor die is mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. A method comprising:
receiving a pointer to a first rule, where the first rule identifies a first portion of a packet;
accessing the first rule, according to the pointer, from a first memory;
based on the first rule, generating a search word that includes the first portion and omits a second portion of the packet;
accessing a second rule, based on the first rule, wherein the second rule identifies a comparing operation to apply against a portion of the search word;
performing the comparing operation according to the second rule;
modifying the packet based on a result of the comparing operation; and
writing the modified packet to a second memory.

2. The method of claim 1, wherein the second rule identifies, for each of a set of comparing operations, a respective portion of the search word and a respective entry from a lookup table to be compared.

3. The method of claim 1, wherein the second memory comprises a data memory configured to store a plurality of packets.

4. The method of claim 3, wherein writing the modified packet is according to a format specified in the first rule.

5. The method of claim 1, wherein receiving the pointer to the first rule includes receiving the pointer from a processor core.

6. The method of claim 1, wherein the first rule is included in a set of rules with a plurality of other rules, wherein the set of rules addresses a plurality of packet types.

7. The method of claim 1, wherein accessing the second rule includes reading the second rule from the first memory according to an offset specified in the first rule.

8. The method of claim 1 further comprising:
writing an event to a scheduler of a processor core, wherein the event corresponds to a function to be run by the processor core.

9. The method of claim 8, wherein the function includes an action performed with respect to the packet.

10. A circuit comprising:
a first set of registers, wherein each register of the first set of registers is configured to receive data for a lookup operation from a respective processor core of a set of processor cores;
a first memory configured to store a first set of rules, a second set of rules, and a set of lookup tables; and
a set of lookup table engines configured to access the first memory and to access data from the first set of registers;
wherein a first lookup table engine of the set of lookup table engines is further configured to:
receive first data from a first processor core, wherein the first data references a first rule of the first set of rules for a first lookup operation and references a location of a packet in a second memory;
generate a search word according to the first rule, including storing a first subset of the packet to a register and omitting to store a second subset of the packet to the register;
access, according to the first rule, a second rule of the second set of rules;
generate, according to the second rule, a comparison value based on a portion of the search word;
compare the comparison value to respective entries from the lookup tables according to the second rule; and
write an event to a scheduler of the first processor core, based at least in part on results of comparing the portion of the search word.

11. The circuit of claim 10, wherein the comparison value includes a plurality of bytes of the search word.

12. The circuit of claim 10, wherein the first rule corresponds to a first packet protocol, further wherein a third rule of the first set of rules corresponds to a second packet protocol, and wherein the first lookup table engine is further configured to generate a further search word according to the third rule for a second lookup operation.

13. The circuit of claim 12, wherein a second lookup table engine of the set of lookup table engines is configured to generate the search word according to the first rule for a third lookup operation and to generate the further search word according to the third rule for a fourth lookup operation.

14. The circuit of claim 10, wherein the first lookup table engine is further configured to receive the first data from the first processor core via the first set of registers.

15. The circuit of claim 10, further comprising a configuration interface, wherein the configuration interface is configured to receive configuration data and to configure the first set of rules, the second set of rules, and the lookup tables according to the configuration data.

16. The circuit of claim 10, further comprising:
a second set of registers, wherein the first lookup table engine is configured to place the results of comparing in the second set of registers in response to determining that the second rule indicates a shared operation, and wherein the second set of registers is configured to be read by each processor core of the set of processor cores.

17. A network accelerator comprising:
a first processor core;
a processor scheduler, communicatively coupled with the first processor core; and
a lookup table engine, communicatively coupled with the processor scheduler, wherein the lookup table engine is configured to:
receive first data from the first processor core, and, in response, access a first rule and a second rule;
generate a search word from a packet referenced in the first data, wherein the search word includes a first portion of the packet and omits a second portion of the packet based on the first rule;
perform a plurality of comparing operations according to the second rule, wherein each comparing operation compares a respective portion of the search word to a respective value from a lookup table entry; and
write an event to the processor scheduler based in part on results of the plurality of comparing operations.

18. The network accelerator of claim 17, further comprising:
a data memory configured to store the packet and configured to store the results of the plurality of comparing operations; and
a lookup table memory configured to store a plurality of rules, including the first rule and the second rule, and also configured to store the lookup table entry.

19. The network accelerator of claim 18, wherein the first data comprises a first pointer to the packet in the data memory and a second pointer to the first rule in the lookup table memory.

20. The network accelerator of claim 17, wherein the first processor core is configured to:
generate the first data to include an indication of the first rule in response to a source of the packet.
